(19) United States
(12) Patent Application Publication
(10) Pub. No.: US 2006/0186137 A1
(43) Pub. Date: Aug. 24, 2006

(54) Dispensing system for beverages and method for cleaning a dispensing system

(76) Inventor: Rudolf Till, Lauf-Aubach (DE)

Correspondence Address: HARNESS, DICKEY & PIERCE, P.L.C., P.O. BOX 828, BLOOMFIELD HILLS, MI, 48303, US

(21) Appl. No.: 11/351,499

(22) Filed: Feb. 10, 2006

Related U.S. Application Data
(63) Continuation of application No. PCT/EP04/07756, filed on Jul. 14, 2004.

(30) Foreign Application Priority Data
Aug. 11, 2003 (DE) 103 37 735.2

(51) Int. Cl. B67D 1/08

(52) U.S. Cl. 222/148

(57) ABSTRACT

A dispensing system for beverages, particularly beer, and a method for cleaning the system are described. The dispensing system comprises a beverage tank, a tap which is located above the beverage tank and is situated at a distance therefrom, and a beverage line whose first, upper end is connected to the tap and whose second, lower end is connected to the beverage tank. A cleaning system for introducing a cleaning agent into the beverage line is also provided. The cleaning system comprises, at the first end of the beverage line, an inlet, and, at the second end of the beverage line, an outlet for the cleaning agent (FIG. 1).

### CROSS REFERENCES TO RELATED APPLICATIONS

This application is a continuation of International patent application PCT/EP2004/007756 filed on Jul. 14, 2004 and published in German language, which International patent application claims priority under the Paris Convention from German patent application DE 103 37 735, filed Aug. 11, 2003.

### FIELD OF THE INVENTION

The invention relates to a dispensing system for beverages, with a beverage tank, with a tap which is located above the beverage tank and is situated at a distance therefrom, with a beverage line whose first, upper end is connected to the tap and whose second, lower end is connected to the beverage tank, and with a cleaning system for introducing a cleaning agent into the beverage line.

The invention also relates to a method for cleaning a dispensing system for beverages, with a beverage tank, with a tap which is located above the beverage tank and is situated at a distance therefrom, and with a beverage line whose first, upper end is connected to the tap and whose second, lower end is connected to the beverage tank.

### BACKGROUND OF THE INVENTION

A dispensing system and a method of the type mentioned above are known from document DE 297 04 794 U1.

In dispensing systems used in bars and restaurants and the like, the taps are generally located on a counter in a taproom. By contrast, the beverage tanks, for example beer barrels or vessels containing other carbonated drinks, are located in a beer cellar which is usually situated under the taproom. The connection between the taps and the beverage tanks is established via beverage lines. These can be up to 80 meters long and can hold a volume of several liters along this length.

For hygiene reasons, it is necessary for the dispensing system, including the beverage lines, to be regularly cleaned. This is usually done after the bar or restaurant has been closed and before the dispensing system is switched off. To clean the beverage line in known dispensing systems, the residual quantity of beverage still left in the beverage line is allowed to run off, and the beverage line is then cleaned. This is normally done by a liquid cleaning agent being introduced into the beverage line and being allowed to stand there for a certain period of time. The cleaning agent is then also allowed to run off, and the system is then flushed several times with a flushing agent, usually water.

It is also known to use suitable sensors to monitor the water lying in the beverage line after the final flushing operation, in order to determine whether the beverage line has been adequately cleaned. If this is not the case, the flushing procedure or even the cleaning procedure is repeated.

In known cleaning systems, the cleaning agent is introduced into the beverage line via a fitting which is located in the beer cellar, specifically in the area of the coupler, i.e. in the area of the connecting means between the beverage tank and the beverage line. The cleaning agent is introduced at a certain pressure from below into the beverage line until it emerges at the top from the tap in the taproom. In this way, it is possible to establish that the entire beverage line is filled with cleaning agent. By suitable switching of the fitting in the area of the coupler, the cleaning agent is likewise allowed to run off at the lower end of the beverage line after the cleaning period has elapsed, and flushing agent is then introduced into the beverage line, again via the said fitting.

This known procedure has several disadvantages:

The first disadvantage is that, at the start of the cleaning procedure, the residual quantity of beverage still left in the beverage line is allowed to run off. Since this residual quantity of beverage can amount to several liters, for the reasons already stated, considerable losses are incurred over the course of time.

In document DE 297 04 794 U1 mentioned in the introduction, it is therefore proposed to provide the tap with a compressed gas attachment. Before the start of a cleaning procedure, this compressed gas attachment is opened while the tap is closed. The compressed gas entering the beverage line then forces the column of beverage lying in the beverage line back down into the beverage tank. By this means, the stated residual quantity of beverage is not lost. After the residual quantity of beverage has been forced back in this way, the actual cleaning procedure then takes place in the manner already described, by means of a cleaning liquid, and later a flushing liquid, being introduced from underneath into the beverage line in the area of the coupler.

However, this has the disadvantage that, when the fitting is switched, cleaning liquid is mixed with the residual quantity of beverage and is conveyed together with the latter into the beverage tank. Moreover, it has happened in practice that bar staff have inadvertently triggered a cleaning procedure during the dispensing operation, and this has not been noticed at the counter area, because the switching and introducing operations take place in the beer cellar, i.e. out of sight of the bar staff. When a cleaning procedure is inadvertently triggered, however, this means that cleaning liquid is inadvertently tapped instead of beverage, or at least beverage containing cleaning agent is inadvertently tapped. This is unacceptable in every respect.

Finally, the known procedure also has the disadvantage that, especially if there is a considerable difference in level between the taproom and the beer cellar, the cleaning agent has to be introduced with the hydrostatic pressure of the liquid column in the beverage line. This requires suitably dimensioned pumps and in turn increases the risk of cleaning agent getting into the beverage tank as a result of the necessary higher pressure.

### SUMMARY OF THE INVENTION

Therefore, the object of the invention is to develop a dispensing system and a method of the type mentioned in the introduction in such a way that these disadvantages are avoided. In particular, the operating safety is to be increased by ruling out the possibility of inadvertent introduction of cleaning agent into the beverage line. In addition, using a lower operating pressure when introducing the cleaning agent is intended to reduce the risk of pressurized cleaning agent inadvertently getting into the beverage tank.

In a dispensing system of the type mentioned in the introduction, this object is achieved, according to the invention, by the fact that the cleaning system comprises, at the first end of the beverage line, an inlet, and, at the second end of the beverage line, an outlet for the cleaning agent.

In a method of the type mentioned in the introduction, the object is achieved, according to the invention, by the fact that switching means are provided in order to attach the second end of the beverage line alternately to the beverage tank or to an outlet or to close it, said method comprising the following steps:
a) knocking off the coupler;
b) connecting the second end of the beverage line to the outlet;
c) introducing a cleaning agent into the first end of the beverage line until the latter is filled;
d) closing the second end of the beverage line;
e) leaving the cleaning agent to stand in the beverage line for a predetermined period of time;
f) connecting the second end of the beverage line to the outlet and allowing the cleaning agent to flow into the outlet;
g) closing the second end of the beverage line;
h) repeating steps c) through g) for n times, a flushing agent being used instead of the cleaning agent;
i) connecting the second end of the beverage line to the beverage tank;
j) striking the coupler into place.

The object on which the invention is based is fully achieved by this means.

Since, in a complete reversal of the known procedure, the cleaning agent is guided from the top downward through the beverage line, it is in the first instance possible to rule out the possibility of inadvertent mixing of cleaning agent and the later tapped beverage. In addition, a much lower pressure is needed to introduce the cleaning agent into the beverage line, because the cleaning agent flows through the beverage line with the help of gravity and does not have to be forced upward counter to the force of gravity.

In a preferred embodiment of the dispensing system according to the invention, the inlet leads through a beverage outflow pipe of the tap.

This measure has the advantage that, during the cleaning procedure, the normal outflow for the beverage that is to be tapped is occupied so that accidental tapping can be completely ruled out during the cleaning procedure.

In a preferred configuration of this illustrative embodiment, this is achieved by the fact that the inlet comprises an attachment means which can be connected manually to the beverage outflow pipe.

This measure has the advantage that it is possible to change from dispensing mode to cleaning mode with just one maneuver.

This applies especially when the attachment means comprises a tube which can be pushed onto the beverage outflow pipe.

In this case it is also particularly preferable if the attachment means comprises an adapter which covers a tap valve of the tap when the attachment means is connected to the beverage outflow pipe.

This measure has the advantage that even accidental actuation of the tap valve in the cleaning operation is avoided.

A further illustrative embodiment of the invention is characterized in that the beverage outflow pipe, in the area of its outflow end, is attached to a pipe connector which communicates with a cleaning agent line, in that a closure element is arranged in the transition from the pipe connector to the beverage outflow pipe, which closure element, in a dispensing position, blocks the beverage outlet pipe relative to the pipe connector and frees it relative to the outflow end, whereas, in a cleaning position, it frees the beverage outflow pipe relative to the pipe connector and closes it relative to the outflow end, and in that an actuating element is provided with which, on the one hand, the closure element can be brought into the dispensing position or into the cleaning position and which, on the other hand, opens a tap valve of the tap in the cleaning position.

This measure has the advantage that complete cleaning of the beverage line all the way into the beverage outflow pipe is possible by automatic means.

In another illustrative embodiment of the invention, the inlet comprises a first switching valve which is arranged at the first end of the beverage line and with which the beverage line can be alternately connected to a beverage outflow pipe or to a pipe connector for introducing the cleaning agent.

This measure has the advantage that the switch from dispensing operation to cleaning operation can take place without interchanging of attachment pieces, in other words semi-automatically or automatically, simply by actuating the first switching valve.

In a preferred development of this illustrative embodiment, the first switching valve can be integrated in the tap. This applies, in a further preferred embodiment, for the pipe connector too.

These measures have the advantage that the elements needed for cleaning the dispensing system in the area of the tap are not seen from the outside and thus also do not get in the way.

In all the preferred illustrative embodiments, it is also advantageous if a sensor is arranged in the beverage line and is used for detecting a state of a substance located in the beverage line.

This measure has the advantage that, at any desired times, it is possible to monitor whether an actual beverage, a cleaning agent, a flushing agent or a mixture of the aforementioned substances is present in the beverage line. Depending on the signal from the sensor, the cleaning and flushing procedures can then be optimally timed and controlled.

A particularly good effect is achieved in another illustrative embodiment of the dispensing system according to the invention in which switching means are provided with which a residual quantity of beverage located in the beverage line can be transferred into the beverage tank before introduction of the cleaning agent into the beverage line.

This measure has the advantage that the residual quantity of beer located in the beverage line is not wasted, with the result that economic operation of the dispensing system is possible.

For this purpose, it is advantageous if the switching means comprise a second switching valve which is arranged at the first end of the beverage line and with which the beverage line can be connected alternately to the tap or to a pressure line.

This measure has the advantage that the forcing back of the residual quantity of beverage into the beverage tank can take place semi-automatically or even fully automatically.

Here too, it is preferred if the second switching valve is integrated in the tap.

In order to force the residual quantity of beverage back into the beverage tank in this illustrative embodiment, a further embodiment of the invention is proposed in which the pressure line is attached to a compressed gas container which can be arranged near the first end or near the second end of the beverage line.

The use of a compressed gas, in particular CO₂, has the advantage that the residual quantity of beverage can be forced back into the beverage tank without any contact with the oxygen of the ambient air, which could lead to deterioration of the residual quantity of beverage.

If the compressed gas container is arranged near the first end of the beverage line, this has the advantage of a short conduit length and therefore a small drop in pressure between the compressed gas container and the first end of the beverage line.

In the alternative case, where the compressed gas container is arranged near the second end of the beverage line, the advantage obtained is that the residual quantity of beverage can be forced back into the beverage tank, and the beverage can be conveyed in the dispensing operation, by using the same compressed gas container normally located in the beer cellar near the beverage tank, for example the beer barrel.

In a further preferred illustrative embodiment of the invention, a third switching valve arranged at the second end of the beverage line is assigned to the outlet, with which third switching valve the beverage line can be attached alternately to the beverage tank or to a disposal line or can be closed.

This measure has the advantage that the beverage line, in the dispensing operation, can be connected to the beverage tank, or, when emptying the cleaning agent or flushing agent, can be connected to an outlet, in both cases in a remote controlled manner, that is to say in an automated or semi-automated manner. In the third operating mode, when the beverage line is closed, a cleaning agent lying in the beverage line is able to act for a predetermined time, and it is possible to avoid a situation where, particularly in beverage lines of large internal diameter, the so-called “pipetting effect” causes the cleaning agent present in the beverage line to run off independently at the lower end.

To avoid this latter effect, provision is made, in another preferred embodiment of the invention, that the outlet at the lower end has a valve that opens starting from a predetermined response pressure. This valve is preferably a non-return valve, and the response pressure is also preferably greater than the hydrostatic pressure in the beverage line and is preferably approximately 0.3 bar.

In this connection, it is finally preferred if the third switching valve is integrated in a coupler for the beverage tank.

This measure has the advantage that all the necessary functions are maintained in full, even when changing the beverage tank, without other attachments having to be separated or produced.

The method according to the invention is preferably further refined such that, in step e), the predetermined period of time is between 10 and 40 minutes and is preferably 20 minutes.

These values have proven particularly effective in practice.

The same applies to the case that, in step h), the number n is between 3 and 7 and is preferably 5.

A good effect is also achieved when the volume of the beverage line is determined in advance, and, in step c), the amount of cleaning agent introduced corresponds to the defined volume.

This applies correspondingly when the volume of the beverage line is determined in advance, and, in step h), the amount of flushing agent introduced corresponds to the defined volume.

The aforementioned measures have the advantage that the minimal amount of cleaning agent and of flushing agent can be used, such that the corresponding procedures run as economically as possible.

In the method according to the invention, it is also preferred if, before step a), the residual quantity of beverage located in the beverage line is forced back into the beverage tank.

A further preferred alternative embodiment of the method according to the invention is characterized in that, directly before or after step j), the quality of the substance located in the beverage line is measured, and, if the measured quality does not conform to a predetermined quality, step h) is then repeated.

This measure has the advantage that, even if the beverage lines are badly contaminated, a renewed dispensing operation is possible only when the beverage line has been returned to a state of predetermined cleanness by means of repetition (if appropriate several times) of the cleaning and flushing steps. The word “substance” is to be understood both as a liquid located in the beverage line and as a deposit located on the inside surface of the beverage line.

Finally, as regards the method, it is preferred if, after step j), the beverage line is blown clear by means of a compressed gas.

This measure has the advantage that all residual amounts of cleaning agent or flushing agent that may be present in the beverage line are removed before the dispensing operation is resumed. The blowing clear with compressed gas also has the advantage that the beverage line does not contain any air oxygen, which would lead to deterioration of the beverage, in particular of beer.

Further advantages will become clear from the description and from the attached drawing.

It will be appreciated that the aforementioned features and the features still to be explained below can be used not only in the respectively cited combination, but also in other combinations or singly, without departing from the scope of the present invention.

### BRIEF DESCRIPTION OF THE FIGURES

Illustrative embodiments of the invention are explained in more detail in the following description and are depicted in the drawing, in which:

FIG. 1 shows an extremely schematic view of a bar or restaurant equipped with a dispensing system according to the invention;

FIG. 2 shows a first illustrative embodiment of a tap for the dispensing system according to FIG. 1;

FIG. 3 shows a view similar to FIG. 2, but for an alternative embodiment of the invention; and

FIG. 4 shows another view similar to FIG. 2, but for a further alternative embodiment of the invention.

### DESCRIPTION OF PREFERRED EMBODIMENTS

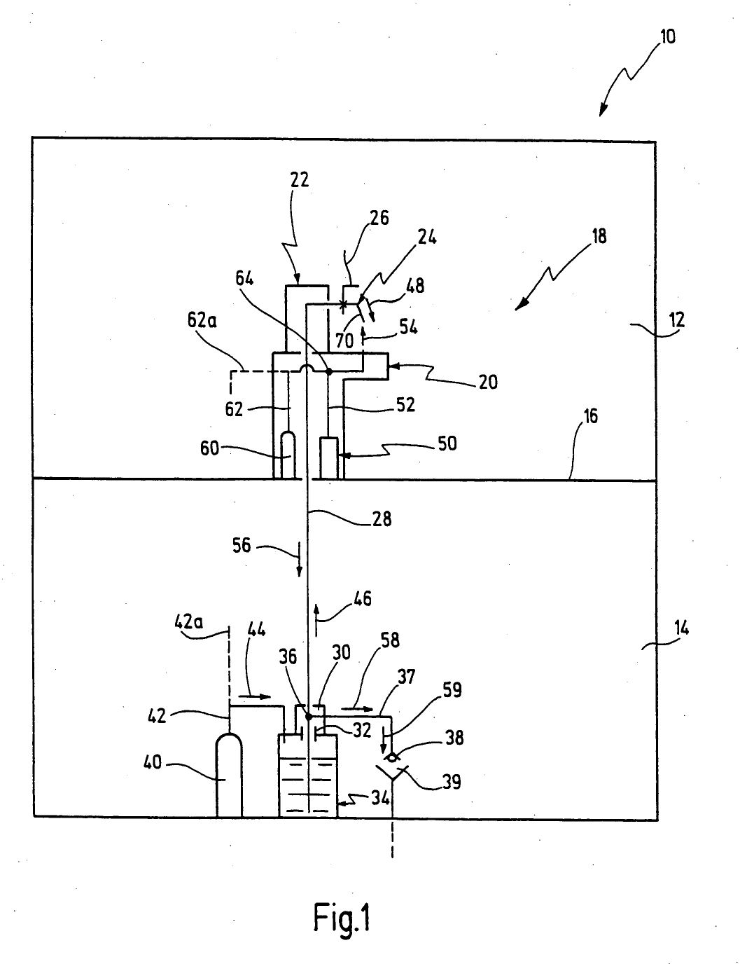

In FIG. 1, reference number 10 designates a bar or restaurant in an extremely schematic form. The bar or restaurant 10 has a taproom 12 and a beer cellar 14 which lies under the taproom 12 and which is separated from the taproom 12 by a ceiling 16. The bar or restaurant 10 is provided with a dispensing system 18 which is partly located in the taproom 12 and partly located in the beer cellar 14.

In the taproom 12 there is a counter 20 on which a tap arrangement 22 for beverages is provided. Beverages are to be understood here mainly as carbonated drinks, in particular beer. However, the present invention is not limited to such beverages, since it is also suitable for other, non-carbonated drinks. For the sake of simplicity, the invention will be explained below taking only beer as one example of a beverage, without this in any way limiting the invention.

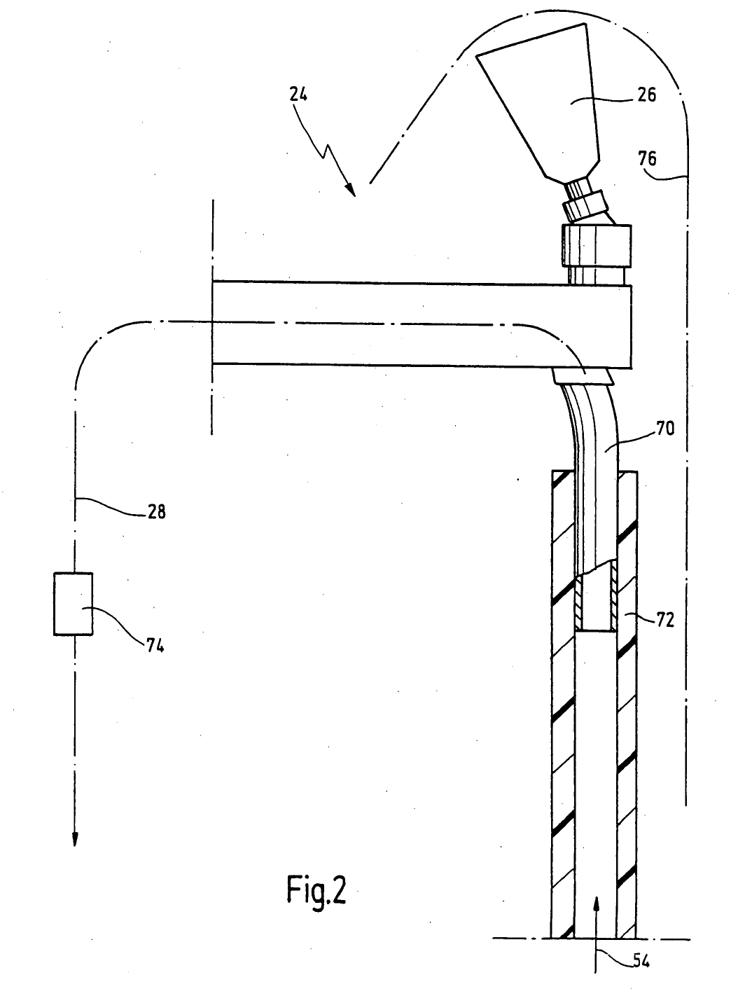

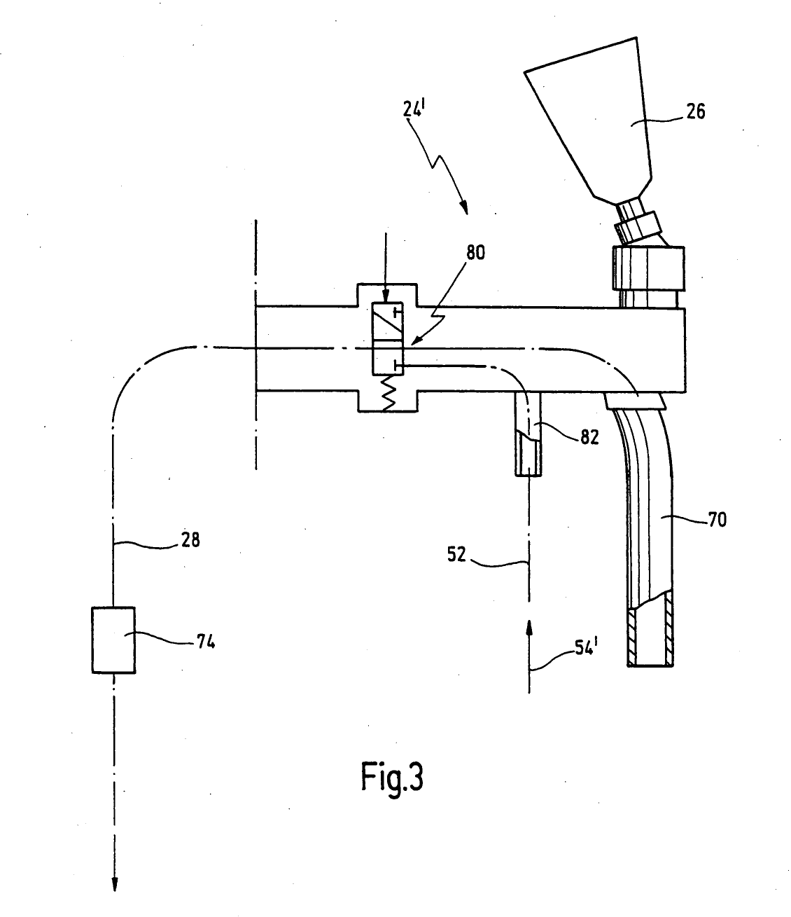

The tap arrangement 22 comprises a tap 24 which is provided with a hand-operated tap valve 26. Illustrative embodiments of the tap 24 are shown on a larger scale in FIGS. 2 and 3 and are explained in more detail with reference to these figures.

From the tap 24, a beverage line or beer line 28 runs through the ceiling 16 into the beer cellar 14 and ends there in a coupler 30 which is mounted on a fitting 32 of a beer barrel 34. In the context of the present invention, the upper end of the beer line 28 is referred to as the “first end” and the lower end is referred to as the “second end”.

A first switching valve 36 is located in the area of the coupler 30. With the first switching valve 36, the beer line 28 can be connected alternately to the beer barrel 34 or to a laterally extending branch line 37 or can be closed.

The branch line 37 leads through a non-return valve 38 to a disposal line 39 which is connected to a conduit or other disposal system.

In the beer cellar 14, in the area of the beer barrel 34, there is a conventional first compressed gas container 40, in particular a CO₂ container, which is connected to the beer barrel 34 via a compressed gas line 42. In one particular illustrative embodiment of the invention, the compressed gas line 42 can have a branch 42a leading upward to the tap arrangement 22. This is explained in more detail below.

To draw beer from the beer barrel 34, the first switching valve 36 is switched to a position in which the beer line 28 is connected to the beer barrel 34. At the same time, by suitable actuation of a valve (not shown) in the compressed gas line 42, a connection is established between the first compressed gas container 40 and the beer barrel 34. In this way, compressed gas is introduced as carrier gas into the beer barrel 34, and beer can be drawn from the tap arrangement 22. To do so, carrier gas flows in the direction of the arrow 44 from the first compressed gas container 40 into the beer barrel 34, so that beer is forced in the direction of the arrow 46 upward through the beer line 28. With the tap 24 opened, the beer emerges from the latter in the direction of the arrow 48 and can be poured into glasses.

To this extent, the dispensing system 18 works in a manner known per se.

The dispensing system 18, in particular the beer line 28, has to be cleaned at regular intervals, particularly in the evenings when bar service has ended. For this purpose, a cleaning system designated overall by reference number 50 is provided. The cleaning system 50 comprises a tank and metering device (not shown) for the cleaning agent. This device is connected to a cleaning agent line 52 which opens out in the area of the tap 24. An arrow 54 indicates that cleaning agent can be introduced into the tap 24. The cleaning agent can flow downward through the beer line 28 in the direction of the arrow 56, then in the direction of the arrow 58 through the branch line 37, where it arrives in the disposal line 39, as is indicated by an arrow 59.

In order to safely separate the cleaning operation from the dispensing operation, and for reasons of economy too, the beer line 28 is preferably forced empty after completion of the dispensing operation. For this purpose, in one illustrative embodiment of the invention, a second compressed gas container 60 is provided in the area of the tap arrangement 22. The second compressed gas container 60 can be connected to the cleaning agent line 52 via a compressed gas line 62 and via a second switching valve 64. Therefore, compressed gas, in particular CO₂, can first be introduced into the tap 24, as a result of which the residual quantity of beer present in the beer line 28 is forced back downward (arrow 56) into the beer barrel 34 before the cleaning procedure begins.

Alternatively, the first compressed gas container 40 can also be used for this step. For this purpose, the aforementioned branch 42a of the compressed gas line 42 is provided which continues at 62a in the area of the tap arrangement 22 and from there leads to the second switching valve 64.

In the context of the present invention, two alternative embodiments of the design of the tap 24 are preferred, which are shown in further detail in FIGS. 2 and 3.

In the first alternative embodiment according to FIG. 2, the usual outflow pipe 70 for the beer can be seen on the underside of the tap 24. For the cleaning operation, the free end of a tube 72 is now pushed onto the outflow pipe 70 so that the cleaning agent can flow in the direction of the arrow 54 through the tube 72 and into the outflow pipe 70 and thus into the beer line 28.

In FIG. 2, reference number 74 designates a sensor which is located in the beer line 28, preferably in the area of the first end of the beer line 28. The sensor 74 is used to measure a quality of the substance located in the beer line 28. The sensor 24 can measure the pH, for example, or the cloudiness or conductivity or other suitable physical or chemical parameter of the substance located in the beer line 28. In this way it is possible to ascertain whether beer (or another beverage) or cleaning liquid or a flushing liquid, for example water, or a mixture of these substances is present in the beer line 28, or whether a deposit has collected on the inside wall of the beer line 28.

Reference number 76, finally, designates an adapter. The adapter 76 has the form of a rigid envelope that surrounds the tap valve 26. The adapter 76 is configured in such a way that, with the tube 72 attached, it covers the tap valve 26 such that inadvertent actuation of the tap valve 26 in this state is ruled out.

In the alternative embodiment of a tap 24′ shown in FIG. 3, a third switching valve 80 is provided in the tap 24′. The third switching valve 80 allows the beer line 28 to be connected alternately to the outflow pipe 70 or to a separate pipe connector 82 to which the cleaning agent line 52 is firmly attached. In the position of the third switching valve 80 shown in FIG. 3, there is a direct connection between the beer line 28 and the outflow pipe 70, whereas, in the position of the third switching valve 80 not shown in FIG. 3, the beer line 28 would be connected to the pipe connector 82 and therefore to the cleaning agent line 52. The third switching valve 80, like the first switching valve 36 and the second switching valve 64, is preferably designed as a solenoid valve and electrically activated. However, manual activation of the third switching valve 80 is also conceivable.

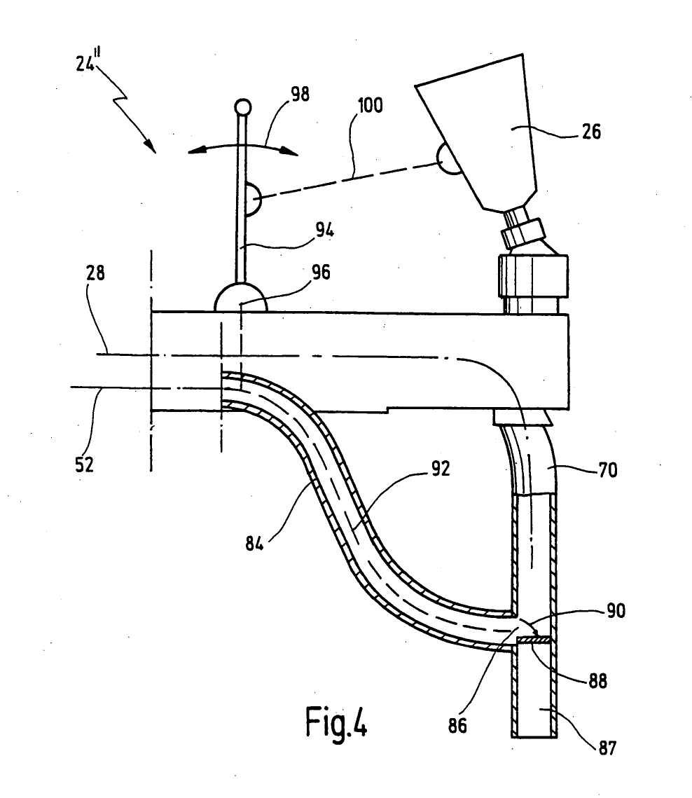

FIG. 4 shows a further alternative embodiment of the invention, with a tap 24″. In the alternative embodiment according to FIG. 4, a pipe connector 84 is connected to the outflow pipe 70 in the area of the lower outflow end 87 of the latter. The pipe connector 84 can be configured as a rigid pipe line or as a flexible tube. At its rear end, the pipe connector 84 is attached to the cleaning agent line 52.

At its lower end, the pipe connector 84 has an opening 86 with which it opens into the outflow pipe 70. A closure element 88 is arranged there which, in the illustrative embodiment shown, is designed as a flap valve, but can equally well be a slide valve or another closure element.

In the position shown in FIG. 4, the closure element 88 is located in a cleaning position. In the cleaning position, the closure element 88 closes the outflow pipe 70 relative to the outflow end 87 and opens it relative to the pipe connector 82 and thus to the cleaning agent line 52. To do this, the closure element 88 is moved in the direction of the arrow 90 into the cleaning position, for which purpose an actuating device 92 is contained in the pipe connector 84. The actuating device 92 can be a Bowden wire, a telescope arrangement, a pull wire or the like. Of course, the closure element 88 can also be configured as a normal switching valve with manual or electrical activation.

In the illustrative embodiment shown, the actuating device 92 is activated via a lever 94 which is articulated in a fulcrum 96 on the tap 24″. When the lever 94 is pivoted to the right in the direction of the arrow 98, for example, this can cause the closure element 88 to move into the cleaning position shown in FIG. 4.

The lever 94 also has a linking rod 100 which connects it in an articulated manner to the tap valve 26. When the lever 94 is pivoted to the right into the cleaning position of the closure element 88, the tap valve 26 is at the same time also moved to the right and thus into the open position.

Cleaning agent can therefore also circulate in the tap 24″, namely from the cleaning agent line 52 through the pipe connector 84, past the closure element 88 and upward through the outflow pipe 70 and the now opened tap valve 26 and into the beverage line 28.

By contrast, when the lever 94 is pivoted to the left in FIG. 4, the linking rod 100 is released, so that the tap valve 26 can now be opened or closed by hand. At the same time, by way of the actuating device 92, the closure element 88 is moved counter to the direction of the arrow 90 into the position not shown in FIG. 4. In this dispensing position, the closure element 88 closes the outflow pipe 70 relative to the pipe connector 84 and frees it relative to the outflow end 87. In this way, beverage can be dispensed in the usual way, because, with the tap valve 26 opened, the beverage can now flow unimpeded through the beverage line 28 into the outflow pipe 70 and out of the outflow end 87.

The dispensing system 18 according to the invention operates as follows:

After completion of the dispensing operation, the residual quantity of beer left in the beer line 28 is preferably first forced back into the beer barrel 34. This can be done using separate switching means which are not shown in the figures but which are known to the skilled person from the document DE 297 04 794 U1 mentioned in the introduction.

In any event, this takes place in a state in which the coupler 30 is still located on the fitting 32, that is to say has not been knocked off. The first switching valve 36 connects the beer line 28 to the beer barrel 34.

Using the components shown in FIG. 1, the residual quantity of beer left in the beer line 28 can thus be forced back by virtue of the fact that compressed gas is conveyed either from the first compressed gas container 40 or from the second compressed gas container 60 into the cleaning agent line 52 and from there into the tap 24, by the second switching valve 64 connecting either the compressed gas line 62 or 62a to the cleaning agent line 52. It is also possible, of course, to establish a direct connection of the compressed gas line 62 or 62a to the beer line 28 in the area of the latter's first end, for which purpose a further switching valve would be needed.

When the residual quantity of beer left in the beer line 28 has been forced back into the beer barrel 34, the coupler 30 can be knocked off. This is done in a manner known per se and therefore does not need to be explained in the context of the present application.

By activating the first switching valve 36, the second, lower end of the beer line 28 is now connected to the outlet system 37 to 39. At the same time, the cleaning agent line 52 is connected manually to the outflow pipe 70 of the tap 24 (first alternative embodiment according to FIG. 2), or the third switching valve 80 is switched in the described manner (second alternative embodiment according to FIG. 3) or the closure element 88 is switched from the dispensing position to the cleaning position (third alternative embodiment according to FIG. 4). In all cases, cleaning agent is now introduced into the first end of the beverage line 28 until the latter is filled. Complete filling of the beer line 28 is guaranteed by the fact that the amount of cleaning agent introduced into the beer line 28 is the amount corresponding exactly to the volume of the beer line 28. This volume is determined by the configuration of the beer line 28 and thus represents a defined value.

Depending on which of the alternative embodiments of the invention is used, the beverage-carrying lines are cleaned all the way to the outflow end 87 of the outflow pipe 70 (FIGS. 2 and 4) or as far as an area upstream of the outflow pipe (FIG. 3).

To ensure that the cleaning agent does not flow off automatically into the disposal line 39 at the lower end of the branch line 37 (so-called “pipetting effect” for greater internal diameters), the non-return valve 38 is provided there. The latter responds only at a defined response pressure which largely corresponds to the hydrostatic pressure in the beer line 28.

Alternatively or in addition, the first switching valve 36 can now be brought into a closure position in which the beer line 28 is closed at the bottom. The cleaning agent now remains for a predetermined period of time in the beverage line. This period of time is preferably between 10 and 40 minutes and is in particular 20 minutes.

After the stated period of time has elapsed, the cleaning agent is allowed to run down out of the beer line 28, or it is forced out of the beer line 28 by compressed gas. For this purpose, the first switching valve 36 is switched back again to a connecting position between the beer line 28 and the branch line 37.

The procedure described above for introducing a cleaning agent is now repeated in a corresponding manner for a flushing agent, as is known per se from the prior art, so that the necessary means and steps for doing this do not have to be gone into in detail again in this context. Mains water is preferably used as the flushing agent. The beer line 28 is flushed several times in this way, preferably between three and seven times. Flushing five times has normally proven sufficient in practice.

During the final flushing procedure, the sensor 74 expediently determines whether the flushing agent (water) lying in the beer line 28 is sufficiently pure, for which purpose its pH value, its conductivity or its cloudiness can be measured. If it is found that the flushing agent is contaminated to a degree which is still above a predetermined limit value, the flushing procedure is repeated once or several times again, or in the case of a considerable deviation also the cleaning procedure, until finally a state is detected which is below the stated limit value.

Finally, the flushing agent located in the beer line 28 is allowed to run off. At least this last procedure is preferably carried out using compressed gas, so that, before the beer flows back into it, the beer line 28 is filled with compressed gas (CO₂) and not with ambient air that contains oxygen.

The beer line 28 can now be connected again to the beer barrel 34 and the coupler 30 can be hammered on. The dispensing system 18 is therefore in a clean state again and is ready for a dispensing operation.

Therefore, what is claimed, is:

1. A dispensing system for beverages, with a beverage tank, with a tap which is located above the beverage tank and is situated at a distance therefrom, with a beverage line whose first, upper end is connected to the tap and whose second, lower end is connected to the beverage tank, and with a cleaning system for introducing a cleaning agent into the beverage line, characterized in that the cleaning system comprises, at the first end of the beverage line, an inlet, and, at the second end of the beverage line, an outlet for the cleaning agent.

2. The dispensing system as claimed in claim 1, characterized in that the inlet leads through a beverage outflow pipe of the tap.

3. The dispensing system as claimed in claim 1, characterized in that the inlet comprises an attachment means which can be connected manually to the beverage outflow pipe.

4. The dispensing system as claimed in claim 2, characterized in that the attachment means comprises a tube which can be pushed onto the beverage outflow pipe.

5. The dispensing system as claimed in claim 3, characterized in that the attachment means comprises an adapter which covers a tap valve of the tap when the attachment means is connected to the beverage outflow pipe.

6. The dispensing system as claimed in claim 4, characterized in that the attachment means comprises an adapter which covers a tap valve of the tap when the attachment means is connected to the beverage outflow pipe.

7. The dispensing system as claimed in claim 2, characterized in that the beverage outflow pipe, in the area of its outflow end, is attached to a pipe connector which communicates with a cleaning agent line, in that a closure element is arranged in the transition from the pipe connector to the beverage outflow pipe, which closure element, in a dispensing position, blocks the beverage outlet pipe relative to the pipe connector and frees it relative to the outflow end, whereas, in a cleaning position, it frees the beverage outflow pipe relative to the pipe connector and closes it relative to the outflow end, and in that an actuating element is provided with which, on the one hand, the closure element can be brought into the dispensing position or into the cleaning position and which, on the other hand, opens a tap valve of the tap in the cleaning position.

8. The dispensing system as claimed in claim 1, characterized in that the inlet comprises a first switching valve which is arranged at the first end of the beverage line and with which the beverage line can be alternately connected to a beverage outflow pipe or to a pipe connector for introducing the cleaning agent.

9. The dispensing system as claimed in claim 8, characterized in that the first switching valve is integrated in the tap.

10. The dispensing system as claimed in claim 7, characterized in that the pipe connector is integrated in the tap.

11. The dispensing system as claimed in claim 1, characterized in that a sensor is arranged in the beverage line and is used for detecting a state of a substance located in the beverage line.

12. The dispensing system as claimed in claim 1, characterized in that switching means are provided with which a residual quantity of beverage located in the beverage line can be transferred into the beverage tank before introduction of the cleaning agent into the beverage line.

13. The dispensing system as claimed in claim 12, characterized in that the switching means comprise a second switching valve which is arranged at the first end of the beverage line and with which the beverage line can be connected alternately to the tap or to a pressure line.

14. The dispensing system as claimed in claim 13, characterized in that the second switching valve is integrated in the tap.

15. The dispensing system as claimed in claim 13, characterized in that the pressure line is attached to a compressed gas container.

16. The dispensing system as claimed in claim 15, characterized in that the compressed gas container is arranged near the first end of the beverage line.

17. The dispensing system as claimed in claim 15, characterized in that the compressed gas container is arranged near the second end of the beverage line.

18. The dispensing system as claimed in claim 1, characterized in that a third switching valve arranged at the second end of the beverage line is assigned to the outlet, with which third switching valve the beverage line can be attached alternately to the beverage tank or to a disposal line or can be closed.

19. The dispensing system as claimed in claim 1, characterized in that the outlet at the lower end has a valve that opens starting from a predetermined response pressure.

20. The dispensing system as claimed in claim 19, characterized in that the valve is a non-return valve.

21. The dispensing system as claimed in claim 18, characterized in that the response pressure is greater than the hydrostatic pressure in the beverage line and is preferably approximately 0.3 bar.

22. The dispensing system as claimed in claim 17, characterized in that the third switching valve is integrated in a coupler for the beverage tank.

23. A method for cleaning a dispensing system for beverages, with a beverage tank, with a tap which is located above the beverage tank and is situated at a distance therefrom, and with a beverage line whose first, upper end is connected to the tap and whose second, lower end is connected to the beverage tank, with switching means being provided in order to attach the second end of the beverage line alternately to the beverage tank or to an outlet or to close it, said method comprising the following steps:
a) knocking off the coupler;
b) connecting the second end of the beverage line to the outlet;
c) introducing a cleaning agent into the first end of the beverage line until the latter is filled;
d) closing the second end of the beverage line;
e) leaving the cleaning agent to stand in the beverage line for a predetermined period of time;
f) connecting the second end of the beverage line to the outlet and allowing the cleaning agent to flow off into the outlet;
g) closing the second end of the beverage line;
h) repeating steps c) through g) for n times, a flushing agent being used instead of the cleaning agent;
i) connecting the second end of the beverage line to the beverage tank;
j) knocking the coupler into place.

24. The method as claimed in claim 23, characterized in that, in step e), the predetermined period of time is between 10 and 40 minutes and is preferably 20 minutes.

25. The method as claimed in claim 23, characterized in that, in step h), the number n is between 3 and 7 and is preferably 5.

26. The method as claimed in claim 23, characterized in that the volume of the beverage line is determined in advance, and in that, in step c), the amount of cleaning agent introduced corresponds to the defined volume.

27. The method as claimed in claim 23, characterized in that the volume of the beverage line is determined in advance, and in that, in step h), the amount of flushing agent introduced corresponds to the defined volume.

28. The method as claimed in claim 23, characterized in that, before step a), the residual quantity of beverage located in the beverage line is forced back into the beverage tank.

29. The method as claimed in claim 23, characterized in that, directly before or after step j), the quality of the substance located in the beverage line is measured, and, if the measured quality does not conform to a predetermined quality, step h) is then repeated.

30. The method as claimed in claim 23, characterized in that, after step j), the beverage line is blown clear by means of a compressed gas.
